(19) United States
(12) Patent Application Publication
(10) Pub. No.: US 2014/0044977 A1
(43) Pub. Date: Feb. 13, 2014

(54) METHOD FOR COATING SUBSTRATES

(71) Applicants: Troy Manning, Ormskirk (GB); Ivan Paul Parkin, London (GB); Mathew Robert Waugh, London (GB)

(72) Inventors: Troy Manning, Ormskirk (GB); Ivan Paul Parkin, London (GB); Mathew Robert Waugh, London (GB)

(73) Assignees: UNIVERSITY COLLEGE LONDON, London (GB); PILKINGTON GROUP LIMITED, ORMSKIRK (GB)

(21) Appl. No.: 13/261,759

(22) PCT Filed: Apr. 17, 2012
(86) PCT No.: PCT/GB12/50844

§ 371 Date: Oct. 17, 2013

(30) Foreign Application Priority Data
Apr. 19, 2011 (GB) 1106553.9

(51) Int. Cl. C03C 17/34

(52) U.S. Cl. CPC C03C 17/3417
USPC 428/432; 427/255.19; 427/248.1; 427/457

(57) ABSTRACT

A method for coating a substrate with a coating having a controlled morphology is disclosed, the method comprising providing a substrate, depositing a nucleating layer on a surface of the substrate using an aerosol assisted deposition method and depositing at least one further layer by chemical vapour deposition. The nucleating layer and further layer preferably comprise tin oxide. The substrate is preferably glass. The method results in high transmittance and a low diffuse transmission across the visible and infrared region.

The present invention relates to a method for coating substrates. In particular, the invention relates to a method of coating glass with a coating of controlled morphology.

In building product glazing a high optical transmission through the glass is often desirable. This optical transmission must therefore be maintained upon deposition of functional coatings onto the glass substrate.

In photovoltaic cells, it is important that the maximum amount of incident light enters into the cell in order to improve the efficiency of the cell this requires a high transparency. Additionally, good contact between the transparent conducting coating and the light absorber layer in the photovoltaic cell is required to limit electrical shorting, yet a high surface area is advantageous for good light absorption.

Chemical vapour deposition (CVD) of diamond is known. Malshe et al Diamond and Related Materials 6 (1977) pp 430-434 report a technique for achieving an ultra-high nucleation density for CVD diamond growth. Han et al Applied Surface Science 254 (2005) pp 2054-2058 report enhanced diamond nucleation on copper substrates by graphite seeding and CO₂ laser irradiation.

Other materials may also be deposited by CVD or spray pyrolysis. Shewale et al Semicond. Sci. Technol. 25 (2010) 115008 report the preparation of fluorine-doped tin oxide films at low substrate temperatures by a spray pyrolysis technique.

Nano-particle films have been reported. WO-A-2007/051994 discloses the use of an aerosol transport operation to produce a nanoparticle film on a heated substrate.

In organic light emitting diodes (OLEDs) good contact between the transparent conductive layer and the light emitting layers is required for high efficiency.

Methods are known for depositing relatively low-haze coatings of transparent conductive oxides on substrates. Such methods are disclosed, for example, in CA-1333515, U.S. Pat. No. 4,788,079(A), U.S. Pat. No. 6,268,059(B1) and U.S. Pat. No. 5,900,275 Unfortunately, previously known methods of depositing relatively low-haze coatings on substrates do not always ensure that the haze at shorter wavelengths is sufficiently low, and they often require additional overlayers or incompatible deposition techniques. There is, therefore, a need to control feature sizes of a coating, in particular of a transparent conductive oxide coating, on a substrate to ensure adequate transmission, especially at shorter wavelengths and a good surface for electrical contacting of further layers. It is an aim of the present invention to address this problem.

The present invention accordingly provides in a first aspect a method for coating a substrate, the method comprising a) providing a substrate, and b) depositing a coating on at least one surface of the substrate, characterised in that depositing the coating comprises i) depositing a nucleating layer on the surface of the substrate using an aerosol assisted deposition method, and ii) depositing at least one further layer by chemical vapour deposition.

The great advantage of the method according to the first aspect of the invention is that the invention allows the control of feature sizes of the coating to change the scattering of light at shorter wavelengths, and may increase the surface area and change the electrical contact with subsequent layers. This maintains high transmission and a low diffuse transmittance across the visible and infrared region, whilst producing a visibly transparent electrically conducting layer. This is particularly important for e.g. building products such as low emissivity glazing which requires high optical transmission and high infrared reflectivity from the coating, and for OLEO devices and thin-film (e.g. cadmium telluride based) solar cells because the electrical contact between the layers and surface area of the surface is of a great importance to improve the current-voltage characteristics and efficiency of the device.

The method, because it involves controlling the morphology and structure of a coating on a substrate by seeding the surface with a nucleating layer deposited by aerosol assisted deposition then depositing a CVD layer above is convenient, efficient and allows the production of coatings with a particular haze in a relatively efficient manner.

Thus, preferably, the method is a method of coating a substrate with a coating of controlled morphology and/or structure.

Preferably, the coating comprises a compound, preferably an oxide.

Preferably, the aerosol assisted deposition method comprises contacting the surface of the substrate with an aerosol of a precursor solution.

Preferably the aerosol assisted deposition method will use an aerosol having a droplet size of 50 μm diameter or smaller. Various methods may be used in order to generate an aerosol having this droplet size. The methods preferably generate aerosols having droplet sizes of 40 μm diameter or smaller, 30 μm diameter or smaller, 20 μm diameter or smaller or 10 μm or smaller. The preferred methods for generating such aerosols (which most preferably produce droplet sizes of 1 μm or smaller) include methods using a Collison-type collision atomiser, an electro-spray aerosol generation or a piezo-electric aerosol generator.

Generally, the precursor solution will comprise a metal oxide precursor, and/or optionally a dopant precursor and/or optionally a solvent. Thus, preferably, at least one layer of the coating comprises a metal oxide.

Preferably, the metal oxide precursor comprises a precursor of tin oxide.

The most preferred tin oxide precursor is (or comprises) monobutyl tin trichloride. Other precursors which are suitable for deposition of tin oxide coatings using the aerosol assisted deposition method include dimethyl tin dichloride (DMT) or tin tetrachloride.

Preferred solvents include methanol, ethanol, propanol (either IPA or n-propanol) and/or water. A mixture of solvents may sometimes be useful.

Generally, the further layer will comprise a layer of a metal oxide, preferably a transparent conductive oxide which is also more preferably tin oxide (in particular doped tin oxide). It is most preferred if the transparent conductive oxide comprises a fluorine doped tin oxide. Preferred fluorine precursors include hydrogen fluoride (HF) and/or trifluoroacetic acid (TFA).

Thus, preferably, both the nucleating layer deposited on the surface of the substrate using an aerosol assisted deposition method and the further layer will comprise tin oxide, preferably fluorine doped tin oxide.

Generally, the temperature of the substrate during deposition of the nucleating layer and/or deposition of the further layer will be in the range of 350° C. to 600° C. The temperature of the substrate is preferably in the range of 350° C. to 550° C. during deposition of the nucleating layer and between 400° C. and 600° C. during deposition of the further layer.

Generally, the coating time during aerosol assisted deposition to deposit the nucleating layer will be 30 minutes or below. The coating time will depend upon the number of droplets per unit volume of the aerosol which is deposited upon the substrate surface taking into account the volume of each individual droplet and the precursor concentration in the droplet. Generally a higher total volume per unit time and higher concentration will mean that a lower coating time is necessary.

Generally the coating time for chemical vapour deposition of the further layer will be 20 seconds or below.

The method according to the first aspect of the invention produces a coated substrate with a nucleating layer and a further layer. In combination, the nucleating layer and further layer tend to have optical haze significantly lower than a coating of the further layer alone.

Consequently, according to a second aspect of the invention, there is provided a coated substrate comprising, a glass substrate and a coating on at least one surface of the substrate, characterised in that the coating comprises i) a nucleating layer and, ii) a transparent conductive further layer wherein the coated substrate has a diffuse transmission of preferably <4% at 400 nm, preferably <1% at 800 nm, and/or a haze across the visible of less than 2%, preferably less than 1.5% and more preferably less than 1.3%.

Preferably, the transparent conductive further layer comprises an oxide, more preferably a metal oxide, most preferably tin oxide especially doped (e.g. F doped tin oxide). Preferably, the nucleating layer comprises tin oxide.

Preferably, the transmission across the visible will be >80%.

Other preferred features of the second aspect of the invention correspond to the features of the first aspect of the invention.

Coated glasses according to the second aspect of the invention (i.e. as produced by the first aspect of the invention) have particular use in low-emissivity glazing and photovoltaics.

In a further aspect, the present invention comprises a double glazing module comprising a coated substrate according to the second aspect of the present invention.

In a further aspect, the present invention comprises a photovoltaic module comprising a coated substrate according to the second aspect of the present invention.

The invention is illustrated by the following figures in which:

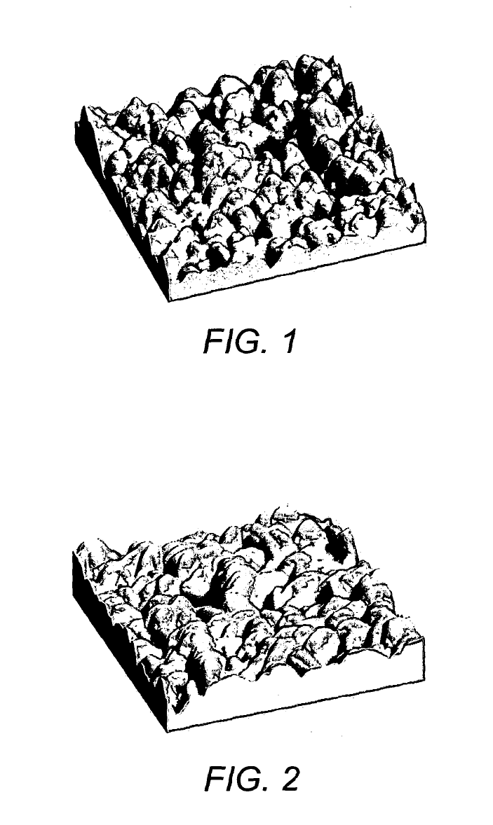

FIG. 1 illustrates AFM results for Comparative Example A,

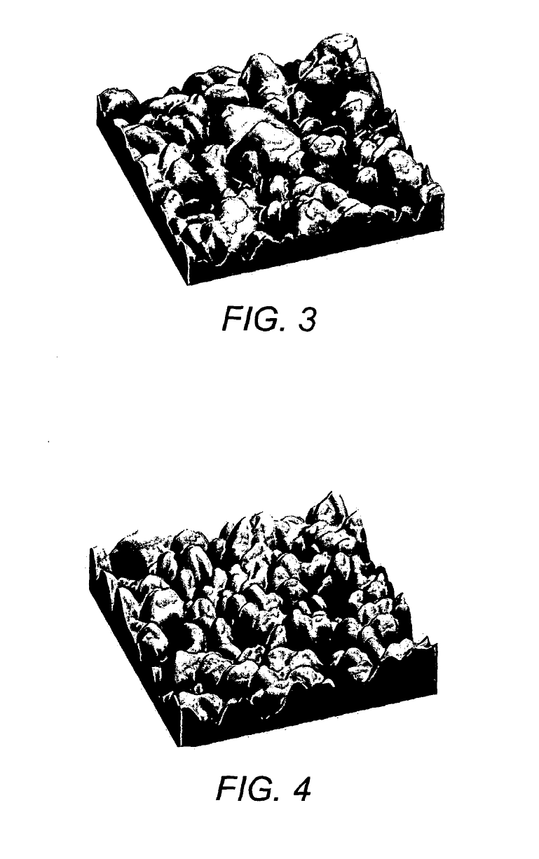

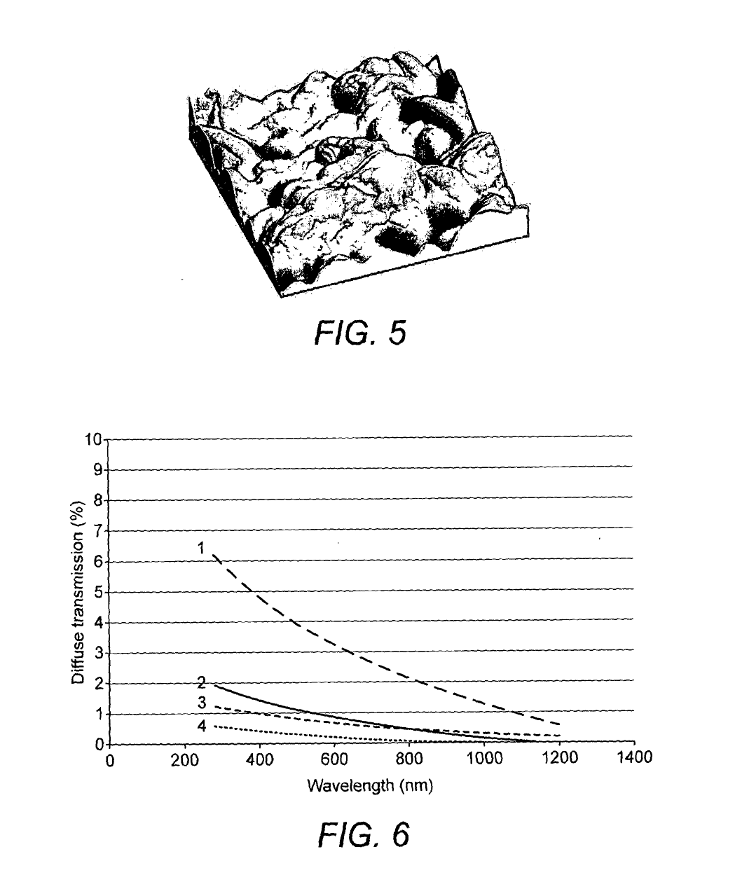

FIGS. 2 to 5 illustrate AFM results for Examples 1 to 4 respectively,

FIG. 6 illustrates diffuse transmission (%) as a function of wavelength for Comparative Example A (curve 1) and Examples 5 to 7 (curves 2, 3 and 4 respectively).

The invention relates to a method by which the surface structure of fluorine doped tin oxide thin films can be altered using a pre-nucleation pathway. This technique shows strong correlation between aerosol deposition time and the following surface parameters; haze value, diffuse transmission, surface roughness average (Ra), and root mean squared height variation (RMSσ). Thus allowing for control over the texturing of the resulting transparent conducting thin films, whereby aerosol pre-nucleation leads to an increase in the aforementioned surface parameters and reduced haze in the coatings. The modified properties of the fluorine doped tin oxide thin films, can be tailored to meet the light scattering performance required for their use in transparent conducting applications, and tailored to suit the surface structure required for thin film photovoltaics.

### Pre-Nucleation of the Substrate Surface Using AACVD

Pre-nucleation of a substrate surface (e.g. glass, quartz, sapphire and plastic), is achieved using Aerosol Assisted Chemical Vapour Deposition. Soluble tin and fluorine precursors (e.g. mono-butyl tin tri-chloride and tri-fluoro acetic acid) with or without a suitable solvent (e.g. methanol), are mixed to form the precursor solution. An aerosol of the precursor solution is then formed using an appropriate aerosol generation method. This method should be capable of producing aerosol droplets of the precursor solution with a diameter of less than 40 μm and preferably less than 1 μm. Suitable aerosol generators may include Collison-type collision atomisers, electro-spray aerosol generators and piezoelectric aerosol generators.

The aerosol of the precursor solution is passed over the heated substrate using a carrier gas (e.g. air/nitrogen/argon). The aerosol droplets approach the heated substrate (evaporation of the solvent occurs—if present). Thermal activation of the reagents occurs, and results in the reaction of precursor species as they approach the surface. This reaction forms fluorine doped tin oxide seed particles, which are in intimate contact with the substrate surface. The size and density distributions of these seed particles can be controlled using the following parameters; substrate temperature, aerosol exposure time, precursor solution composition, aerosol droplet size, solvent type, gaseous dilution of the aerosol feed.

The seeded substrate surface is then used as a nucleation surface for the Atmospheric Pressure Chemical Vapour Deposition of the Fluorine doped tin oxide thin film with controlled surface texturing.

Fluorine Doped Tin Oxide Thin Film Formation Using APCVD onto a Pre-Nucleated Substrate (Generated by AACVD)

Atmospheric Pressure Chemical Vapour Deposition is widely used as a fast and commercially viable route to the formation of fluorine doped tin oxide thin films. APCVD involves the gaseous reaction of the appropriate precursor set to form the fluorine doped tin oxide thin film.

The pre-nucleated seeded substrate formed by AACVD is coated with a fluorine doped tin oxide thin film using APCVD, whereby the size and density distribution of the fluorine doped tin oxide seed particles controls the surface texturing of the resulting thin film. The properties of the final fluorine doped tin oxide thin film are governed by, the size and density distributions of the seeded particles on the pre-nucleated substrate, deposition temperature, APCVD precursor set, flow rates, bubbler temperatures.

Additional thin film layers may be coated on top of the modified surface.

### Overall Process

This invention allows for control over the surface texturing of fluorine doped tin oxide thin films formed by APCVD. APCVD is currently used industrially to produce fluorine doped tin oxide thin films, however offers little control over the surface texture and light scattering properties of the material. Post-deposition modification stages are currently available to modify the surface structure. However, this invention allows for pre-deposition modification in the industrial process to achieve control over the surface structure. The rapid processing time of the pre-nucleation stage and the simplicity of the equipment used in this stage, mean that modifications to the APCVD process at an industrial scale are easily achievable at a low cost, with little effort and the process functions as a continual production line. This modification to the CVD technique allows for the production of highly functional thin films with no need for further post-deposition treatment requiring batch processing.

Control over the AACVD and APCVD techniques in tandem, allows for the production of fluorine doped tin oxide thin films for use in transparent conducting applications, where specific values for the following surface properties are required; haze value, diffuse transmission, surface roughness average (Ra), and root mean squared height variation (RMSσ).

This invention can be extended to other thin film materials (other than fluorine doped tin oxide), or as an addition to other thin film deposition techniques (other than APCVD), where control over surface structure is required in the product.

### EXAMPLES 1 TO 7 AND COMPARATIVE EXAMPLE A

The invention is further illustrated by the following Examples and Comparative Example.

Deposition of the nucleating layer by Aerosol Assisted Chemical Vapour Deposition (AACVD) and the further chemical vapour deposition layer was accomplished using a horizontal-bed, quartz, cold-walled tubular carbon reactor with a laminar gas flow for the deposition of the precursor onto the substrate. The horizontal tubular reactor with a cross sectional area of 10 cm³ was fitted with a top plate above the substrate to limit the longitudinal roll convection and provide a laminar gas/aerosol flow.

A Collison type atomizer was used to generate an aerosol for AACVD of small droplet diameter. The precursor solution was delivered as an aerosol which was created using a TSI 3076 constant output Collison type atomizer, using compressed air as the carrier gas (air pressure 30 psi (207 kPa)). This type of aerosol generator produces a constant droplet concentration of around 107/cm³ and a mean droplet diameter of 0.3 μm.

The aerosol solution was prepared using mono-butyl tin chloride (MBTC) trifluoroacetic acid (TFA) and varying volumes of methanol. The substrate temperature was 500° C. and the molar ratio of F/Sn was 30% in the precursor solution. The AACVD deposition time was varied between 3 seconds and 30 minutes.

Sodium Barrier glass (50 nm layer of SiO₂ coated on to float glass) was used as the substrate material to avoid leaching of ionic impurities from the glass. The substrates were cleaned using isopropyl alcohol (IPA) and acetone.

The further layer was deposited on the nucleating layer using atmospheric pressure chemical vapour deposition (APCVD) of fluorine doped tin oxide (F:SnO₂).

Monabutyl tin trichloride (MBTC) was used as the APCVD tin precursor delivered by a heated bubbler (165° C., 0.5 Lmin⁻¹). Aqueous trifluoroacetic acid was used as the fluorine source delivered by a syringe driver through a heated evaporator (0.5 ml min⁻¹, 10 vol % acid in water, 200° C.). A gas flow of ethyl acetate was used as the oxygen source (65° C., 3 Lmin⁻¹) and a plain flow of nitrogen carrier gas at 5 Lmin⁻¹. The deposition was on the substrate pre-coated with the nucleating layer at a temperature of 500° C. Coating time for APCVD was 10 seconds.

The conditions of deposition are summarised in Table 1, below.

TABLE 1

| Example | Condition | Deposition Conditions |
|---|---|---|
| 1 | A | 30 seconds of AACVD (6 vol % MBTC in methanol) |
| | | then 10 s APCVD |
| 2 | B | 60 seconds of AACVD (6 vol % MBTC in methanol) |
| | | then 10 s APCVD |
| 3 | C | 600 seconds of AACVD (6 vol % MBTC in methanol) |
| | | then 10 s APCVD |
| 4 | D | 1800 seconds of AACVD (6 vol % MBTC in |
| | | methanol) then 10 s APCVD |
| 5 | E | 10 seconds of AACVD (100% MBTC) then 10 s |
| | | APCVD |
| 6 | F | 3 seconds of AACVD (100% MBTC) then 10 s |
| | | APCVD |
| 7 | G | 30 seconds of AACVD (100% MBTC) then 10 s |
| | | APCVD |

The films were optically transparent and AACVD layer growth rates were between 5-150 nm/min. The films were free from pin-hole defects, indicating that the deposition process did not involve any large scale gas-phase nucleation. The films showed good adhesion to the glass substrate passing both the Scotch tape test and steel scalpel scratch test. This property indicates that the films are likely to be growing from finely attached nucleation points at the surface and so are suitable for commercial applications.

Scanning Electron Microscopy was performed to determine surface topology and film thickness using a JEOL JSM-6301F Field Emission SEM at an accelerating voltage of 5 keV, SEM showed that the coatings were generally particulate in nature with particles of generally similar size.

Atomic Force Microscopy analysis was performed using a Veeco Dimension 3100 in intermittent contact mode, where a cantilever with an attached tip oscillates at its resonant frequency, and was scanned across the surface of the films to determine the morphology. Results are illustrated for comparative Examples A and Examples 1, 2, 3, and 4 in FIGS. 1 to 5 respectively.

Optical haze measurements were performed on the samples. The results of haze measurement on the samples, against wavelength of light are illustrated in FIG. 6. As can been seen from FIG. 6, the deposition of the nucleating layer results in a significant decrease in diffuse transmission in the UV, visible and near infrared regions. This is greatly advantageous because use of such coated substrates in low emissivity building products will increase window clarity.

Measures of haze for Comparative Example A and Examples 5 to 7 are described in Table 2.

TABLE 2
Haze and diffuse transmission values for a range of coatings without
and with nucleating layers.

| | Haze Across | Diffuse | Diffuse |
|---|---|---|---|
| | the Visible | Transmission | Transmission |
| | (T_{diffuse}/Tₜₒₜₐₗ) | at 400 nm | at 800 nm |
| Sample | (%) | (%) | (%) |
| Tin Oxide coating without a | 3.33 | 4.8 | 2.1 |
| nucleating Layer (Curve 1, | | | |
| Comparative Example A) | | | |
| Nucleating Layer and Further | 1.24 | 1.4 | 0.5 |
| Tin oxide Layer (Example 5, | | | |
| Condition E, Curve 2). | | | |
| Nucleating Layer and Further | 0.51 | 1.0 | 0.5 |
| Tin oxide Layer (Example 6, | | | |
| Condition F, Curve 3). | | | |
| Nucleating Layer and Further | 0.53 | 0.4 | 0.1 |
| Tin oxide Layer (Example 7, | | | |
| Condition G, Curve 4). | | | |

Table 2 tabulates the total % haze across the visible, and the diffuse % transmittance at 400 nm and 800 nm, for Examples 5 to 7.

Table 3 tabulates the AFM derived surface parameters of Examples 1 to 4,

TABLE 3
Surface parameters attained from AFM data for a tin oxide coating
without a nucleating layer and examples 1-4 of tin oxide coatings with a
nucleating layer (Conditions A, B, C and D)

| | RMSσ | | | Surface |
|---|---|---|---|---|
| Sample | (nm) | Ra(nm) | Wq | Area (μm²) |
| Tin Oxide coating without a | 27.5 | 21.8 | 25.75 | 4.61484 |
| nucleating Layer (Comparative | | | | |
| Example A) | | | | |
| Nucleating Layer and Further | 22.6 | 17.9 | 16.8 | 4.61 |
| Tin oxide Layer (Example 1, | | | | |
| Condition A), | | | | |
| Nucleating Layer and Further | 26.2 | 20.7 | 24.58 | 4.615 |
| Tin oxide Layer (Example 2, | | | | |
| Condition 8), | | | | |
| Nucleating Layer and Further | 24.6 | 19.5 | 21.24 | 4.706 |
| Tin oxide Layer (Example 3, | | | | |
| Condition C). | | | | |
| Nucleating Layer and Further | 51.9 | 42.5 | 38.24 | 4.85044 |
| Tin oxide Layer (Example 4, | | | | |
| Condition D), | | | | |

AFM statistical analysis of the coating surfaces for comparative Example A and Examples 1-4 are illustrated in Table 3. The values show that pre-nucleation by the aerosol technique, may cause increased surface area and an increase in the root mean square waviness of the coatings. This is greatly advantageous for use in thin film photovoltaics. A large surface area and good electrical contact due to the longer wavelength of surface features will increase efficiency and reduce electrical shorting problems.

1-12. (canceled)

13. A method for coating a substrate, the method comprising
a) providing a substrate, and
b) depositing a coating on at least one surface of the substrate, characterised in that depositing the coating comprises
i) depositing a nucleating layer on the surface of the substrate using an aerosol assisted deposition method, and
ii) depositing at least one further layer by chemical vapour deposition,
wherein the substrate comprises glass, quartz, sapphire or plastics, wherein the temperature of the substrate during deposition of the nucleating layer and/or the further layer is in the range of 350° to 600° C., wherein the nucleating layer comprises a metal oxide and the further layer comprises a metal oxide and wherein the coating time during the aerosol assisted deposition is 30 minutes or below and wherein the coating time during the chemical vapour deposition is 20 seconds or below.

14. The method as claimed in claim 13, wherein the aerosol assisted deposition method comprises contacting the surface of the substrate with an aerosol of a precursor solution.

15. The method as claimed in claim 13, wherein the aerosol assisted deposition method uses an aerosol having a droplet size of 50 μm diameter or smaller.

16. The method as claimed in claim 13, wherein the at least one further layer comprises a layer of a transparent conductive oxide.

17. The method as claimed in claim 16, wherein the transparent conductive oxide comprises tin oxide, preferably fluorine doped tin oxide.

18. The method as claimed in claim 16, wherein the transparent conductive oxide comprises fluorine doped tin oxide.

19. The method as claimed in claim 14, wherein the precursor solution comprises a metal oxide precursor, a dopant precursor and optionally a solvent.

20. The method as claimed in claim 19, wherein the metal oxide precursor comprises a precursor of tin oxide.

21. The method as claimed in claim 20, wherein the precursor of tin oxide comprises tin chloride, dimethyl tin dichloride or monobutyl tin trichloride.

22. The method as claimed in claim 13, wherein the aerosol assisted deposition method uses an aerosol generated by a method using a Collison-type collision atomiser, an electro-spray aerosol generation or a piezo electric aerosol generator.

23. A coated substrate comprising,
a glass substrate and a coating on at least one surface of the substrate, characterised in that the coating comprises
i) a nucleating layer comprising a metal oxide, and
ii) a transparent, conductive further layer comprising a metal oxide wherein the coated substrate has a diffuse transmission of ≦2% at 400 nm, a diffuse transmission of <1% at 800 nm and a total haze across the visible of ≦2%.

24. A photovoltaic module comprising a coated substrate as claimed in claim 23.

25. A double glazed unit comprising a coated substrate as claimed in claim 23.
